(19) United States
(12) Patent Application Publication
(10) Pub. No.: US 2006/0199076 A1
(43) Pub. Date: Sep. 7, 2006

(54) Hydrogen-absorbing alloy for alkaline storage batteries and alkaline storage battery

(76) Inventors: Shigekazu Yasuoka, Kobe-shi (JP); Yoshifumi Magari, Kobe-shi (JP); Tetsuyuki Murata, Kobe-shi (JP); Jun Ishida, Kobe-shi (JP); Tetsuo Kadohata, Kobe-shi (JP)

Correspondence Address: KUBOVCIK & KUBOVCIK, SUITE 710, 900 17TH STREET NW, WASHINGTON, DC, 20006, US

(21) Appl. No.: 11/356,448

(22) Filed: Feb. 17, 2006

(30) Foreign Application Priority Data
Feb. 17, 2005 (JP) 2005-039927

(51) Int. Cl. H01M 4/58; C22C 19/03; C22C 19/05

(52) U.S. Cl. 429/218.2; 420/443; 420/444; 420/446; 420/451; 420/455; 420/457; 420/459; 420/460; 420/900

(57) ABSTRACT

An alkaline storage battery provided with a positive electrode (1), a negative electrode (2), and an alkaline electrolyte solution employs a hydrogen-absorbing alloy containing: at least a rare-earth element, magnesium, nickel, and aluminum, the hydrogen-absorbing alloy being represented by the general formula Ln₁₋ₓMgₓNi_{y-a-b}AlₐM_{b}, where: Ln is at least one element selected from the group consisting of Ti, Zr, and a rare-earth element including Y; M is at least one element selected from the group consisting of V, Nb, Ta, Cr, Mo, Mn, Fe, Co, Ga, Zn, Sn, In, Cu, Si, P, B, and Zr; 0.05≦x≦0.35; 0.05≦a≦0.30; 0≦b≦0.5; 2.8≦y-a-b≦3.9; and the hydrogen-absorbing alloy having a main phase composed of a uniform metal phase with a uniform composition that has an area percentage of 60% or greater.

### BACKGROUND OF THE INVENTION

1. Field of the Invention

The present invention relates to a hydrogen-absorbing alloy for alkaline storage batteries and an alkaline storage battery using the hydrogen-absorbing alloy for alkaline storage batteries for its negative electrode. More particularly, the invention relates to an alkaline storage battery employing a hydrogen-absorbing alloy containing at least a rare-earth element, magnesium, nickel, and aluminum in the negative electrode so as to enhance the capacity of the alkaline storage battery, and a feature of the invention is to prevent the hydrogen-absorbing alloy from pulverizing when the battery undergoes repeated charge-discharge cycles, and to thereby improve the cycle life of the alkaline storage battery.

2. Description of Related Art

Conventionally, nickel-cadmium storage batteries have been commonly used as alkaline storage batteries. In recent years, nickel-metal hydride storage batteries using a hydrogen-absorbing alloy as a material for the negative electrode have drawn considerable attention in that they have higher capacity than nickel-cadmium storage batteries and that, being free of cadmium, they are more environmentally safe.

As the nickel-metal hydride storage batteries have been used in various portable devices, demands for further higher performance in the nickel-metal hydride storage batteries have been increasing.

In the nickel-metal hydride storage batteries, hydrogen-absorbing alloys such as a rare earth-nickel hydrogen-absorbing alloy having a CaCu₅ crystal structure as its main phase and a Laves phase hydrogen-absorbing alloy containing Ti, Zr, V and Ni are generally used for their negative electrodes.

Generally, these hydrogen-absorbing alloys, however, do not necessarily have sufficient hydrogen-absorbing capability, and it has been difficult to further increase the capacity of the nickel-metal hydride storage batteries.

In recent years, it has been proposed to improve the hydrogen-absorbing capability of the rare earth-nickel hydrogen-absorbing alloy by using a hydrogen-absorbing alloy having a Ce₂Ni₇ type or a CeNi₃ type crystal structure, rather than the CaCu₅ type, by adding Mg or the like to the rare earth-nickel hydrogen-absorbing alloy. (See, for example, Japanese Published Unexamined Patent Application No. 11-323469.)

Nevertheless, when an alkaline storage battery that utilizes the just-mentioned hydrogen-absorbing alloy for the negative electrode undergoes repeated charge-discharge cycles, the hydrogen-absorbing alloy pulverizes, promoting its oxidization and thus degrading the cycle life of the alkaline storage battery.

### BRIEF SUMMARY OF THE INVENTION

is an object of the invention to resolve the foregoing and other problems in an alkaline storage battery using, for the negative electrode, a hydrogen-absorbing alloy containing at least a rare-earth element, magnesium, nickel, and aluminum and having a crystal structure other than the CaCu₅ crystal structure, and it is an object of the invention to prevent the hydrogen-absorbing alloy from pulverizing when the alkaline storage battery undergoes repeated charge-discharge cycles and thereby improve the cycle life of the alkaline storage battery.

In order to accomplish the foregoing object, the invention utilizes a hydrogen-absorbing alloy for alkaline storage batteries in an alkaline storage battery provided with a positive electrode, a negative electrode employing the hydrogen-absorbing alloy, and an alkaline electrolyte solution, the hydrogen-absorbing alloy containing at least a rare-earth element, magnesium, nickel, and aluminum, the hydrogen-absorbing alloy being represented by the general formula Ln₁₋ₓMgₓNi_{y-a-b}AlₐM_{b} (where: Ln is at least one element selected from the group consisting of Ti, Zr, and a rare-earth element including Y; M is at least one element selected from the group consisting of V, Nb, Ta, Cr, Mo, Mn, Fe, Co, Ga, Zn, Sn, In, Cu, Si, P, B, and Zr; 0.05≦x≦0.35; 0.05≦a≦0.30; 0≦b≦0.5; 2.8≦y−a−b≦3.9); and the hydrogen-absorbing alloy having a main phase composed of a uniform metal phase with a constant, or uniform, composition, the main phase having an area percentage in a cross-section of the alloy of 60% or greater.

As described above, the invention utilizes, for the negative electrode of the alkaline storage battery, a hydrogen-absorbing alloy containing at least a rare-earth element, magnesium, nickel, and aluminum, the hydrogen-absorbing alloy being represented by the general formula Ln₁₋ₓMgₓNi_{y-a-b}AlₐM_{b} (where: Ln is at least one element selected from the group consisting of Ti, Zr, and a rare-earth element including Y; M is at least one element selected from the group consisting of V, Nb, Ta, Cr, Mo, Mn, Fe, Co, Ga, Zn, Sn, In, Cu, Si, P, B, and Zr; 0.05≦x≦0.35; 0.05≦a≦0.30; 0≦b≦0.5; 2.8<y-a-b ≦3.9). Therefore, the hydrogen-absorbing capability in the negative electrode improves, making it possible to attain a high capacity alkaline storage battery.

Moreover, this invention utilizes a hydrogen-absorbing alloy in which the area ratio of the main phase composed of a uniform metal phase with a uniform composition in a cross-section of the alloy is 60% or greater. This makes it possible to prevent the hydrogen-absorbing alloy from pulverizing and being oxidized even when the alkaline storage battery adopting the hydrogen-absorbing alloy for the negative electrode undergoes repeated charge-discharge cycles, thus preventing degradation of the cycle life of the alkaline storage battery.

### BRIEF DESCRIPTION OF THE DRAWINGS

FIG. 1 is a schematic cross-sectional view of an alkaline storage battery fabricated in the examples and comparative examples of the invention.

### DETAILED DESCRIPTION OF THE INVENTION

The present invention utilizes a hydrogen-absorbing alloy for alkaline storage batteries in an alkaline storage battery provided with a positive electrode, a negative electrode employing the hydrogen-absorbing alloy, and an alkaline electrolyte solution. The hydrogen-absorbing alloy contains at least a rare-earth element, magnesium, nickel, and aluminum, and the hydrogen-absorbing alloy is represented by the general formula Ln₁₋ₓMgₓNi_{y-a-b}AlₐM_{b} (where: Ln is at least one element selected from the group consisting of Ti, Zr, and a rare-earth element including Y; M is at least one element selected from the group consisting of V, Nb, Ta, Cr, Mo, Mn, Fe, Co, Ga, Zn, Sn, In, Cu, Si, P, B, and Zr; 0.05≦x≦0.35; 0.05≦a≦0.30; 0≦b≦0.5; 2.8≦y-a-b≦3.9). The hydrogen-absorbing alloy has a main phase composed of a uniform metal phase with a uniform composition, and the area percentage of the main phase in a cross-section of the alloy is 60% or greater.

Moreover, it is preferable that in the hydrogen-absorbing alloy for alkaline storage batteries, the area ratio of the main phase composed of a uniform metal phase with a uniform composition be 90% or greater, and more preferably 95% or greater.

An observation of the hydrogen-absorbing alloy with electron probe microanalysis (EPMA) and a scanning electron microscope (SEM) has revealed that a portion with a large Mg content and a portion with a small Mg content tend to be separated easily in the hydrogen-absorbing alloy. For that reason, in the hydrogen-absorbing alloy of this kind, the amount of Mg in the hydrogen-absorbing alloy is reduced to improve the degree of uniformity of the hydrogen-absorbing alloy, in order to increase the area ratio of the main phase composed of a uniform metal phase with a uniform composition. Moreover, in preparing the hydrogen-absorbing alloy through melting, cast-molding, and annealing hydrogen-absorbing alloy materials, the structure of the hydrogen-absorbing alloy is made more uniform in quality by cast-molding and annealing, in order to further increase the area ratio of the main phase composed of a uniform metal phase with a uniform composition.

### EXAMPLES

Hereinbelow, examples of the hydrogen-absorbing alloy for alkaline storage batteries and the alkaline storage battery according to the invention are specifically described along with comparative examples, and it will be demonstrated that in the examples of the alkaline storage battery according to the invention, the hydrogen-absorbing alloy is prevented from pulverizing and thus the cycle life of the battery is improved. It should be noted that the hydrogen-absorbing alloy for alkaline storage batteries and the alkaline storage battery according to the invention are not limited to the examples illustrated in the following, and various changes and modifications are possible within the scope of the invention.

### Example 1

In Example 1, a hydrogen-absorbing alloy powder for the negative electrode was prepared as follows. Rare-earth elements La, Pr, and Nd were mixed with Mg, Ni, Al, and Co so that a predetermined alloy composition was obtained. Thereafter the mixture was melted at 1500° C. by an induction furnace, and was then cooled to obtain an ingot of hydrogen-absorbing alloy. The composition of the resultant hydrogen-absorbing alloy was analyzed by inductively-coupled plasma spectrometry (ICP), and consequently, the composition of the hydrogen-absorbing alloy was found to be (La_{0.2}Pr_{0.5}Nd_{0.3})_{0.83}Mg_{0.17}Ni_{3.03}Al_{0.17}CO_{0.10}.

The ingot of the hydrogen-absorbing alloy was annealed at 950° C. for 10 hours in an argon atmosphere, and thereafter the ingot of the hydrogen-absorbing alloy was mechanically pulverized in an inert atmosphere, whereby a powder of the hydrogen-absorbing alloy with the foregoing composition was obtained. Here, the resultant hydrogen-absorbing alloy powder was analyzed by a laser diffraction/scattering particle size analyzer to determine its particle size distribution, and it was found that the weight-average particle size was 65 μm.

Then, 0.4 parts by weight of sodium polyacrylic acid, 0.1 parts by weight of carboxymethylcellulose, and 2.5 parts by weight of polytetrafluoroethylene dispersion solution (dispersion medium: water, solid content: 60 weight %) were mixed with 100 parts by weight of the foregoing hydrogen-absorbing alloy powder to prepare a paste. The resultant paste was applied onto both sides of a conductive core made of a 60-μm thick nickel-plated punched metal, and then dried. The resultant material was pressed and thereafter cut into predetermined dimensions. Thus, a hydrogen-absorbing alloy electrode to be used as a negative electrode was prepared.

A positive electrode was prepared as follows. Nickel hydroxide powder containing 2.5 weight % of zinc and 1.0 weight % of cobalt was put into an aqueous solution of cobalt sulfate, and 1 mole of an aqueous solution of sodium hydroxide was gradually dropped into the mixture with stirring to cause them to react with each other until the pH became 11; thereafter, the resulting precipitate was filtered, washed with water, and vacuum dried. Thus, nickel hydroxide, the surface of which was coated with 5 weight % cobalt hydroxide, was obtained. Then, a 25 weight % aqueous solution of sodium hydroxide was added and impregnated to the nickel hydroxide, the surface of which was coated with cobalt hydroxide, at a weight ratio of 1:10, and the resultant was heated at 85° C. for 8 hours with stirring; thereafter, this was washed with water and dried at 65° C., whereby a positive electrode material was obtained, in which the surface of the just-described nickel hydroxide was coated with sodium-containing cobalt oxide.

Subsequently, 95 parts by weight of the positive electrode material thus prepared, 3 parts by weight of zinc oxide, and 2 parts by weight of cobalt hydroxide were mixed together, and 50 parts by weight of an aqueous solution of 0.2 weight % hydroxypropylcellulose was added to the mixture and mixed together to prepare a slurry. The slurry was then filled into a nickel foam (surface density: about 600 g/m², porosity: 95%). The resultant was dried and pressed, and thereafter cut into predetermined dimensions. Thus, a positive electrode was prepared, which was composed of a non-sintered nickel electrode.

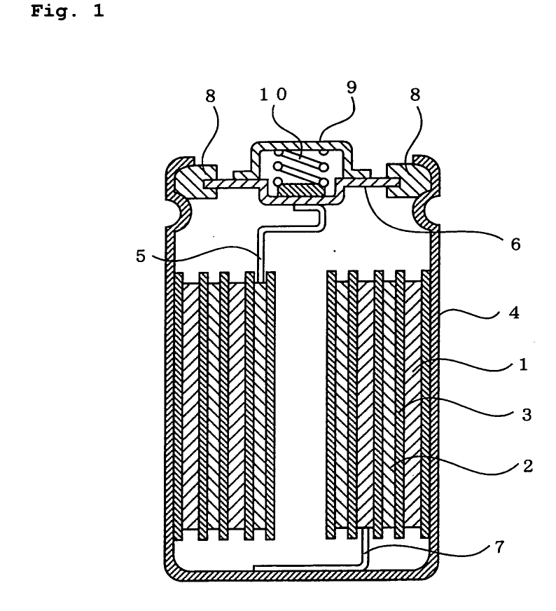

A nonwoven fabric made of polypropylene was used as a separator. An alkaline electrolyte solution used was an alkaline aqueous solution containing KOH, NaOH, and LiOH—H₂0 at a weight ratio of 8:0.5:1 in the total quantity of 30 weight %. Using these components and the negative electrode and positive electrode prepared above, an alkaline storage battery with a cylindrical shape as illustrated in FIG. 1 was fabricated, which had a design capacity of 1500 mAh.

The just-described alkaline storage battery was fabricated according to the following manner. A positive electrode 1 and a negative electrode 2 were spirally coiled with a separator 3 interposed therebetween, as illustrated in FIG. 1, and these were accommodated in a battery can 4. Then, the alkaline electrolyte solution was poured into the battery can 4. Thereafter, an insulative packing 8 was placed between the battery can 4 and a positive electrode cap 6, and the battery can 4 was sealed. The positive electrode 1 was connected to the positive electrode cap 6 by a positive electrode lead 5, and the negative electrode 2 was connected to the battery can 4 via a negative electrode lead 7. The battery can 4 and the positive electrode cap 6 were electrically insulated by the insulative packing 8. A coil spring 10 was placed between the positive electrode cap 6 and a positive electrode external terminal 9. The coil spring 10 can be compressed to release gas from the interior of the battery to the atmosphere when the internal pressure of the battery unusually increases.

### Example 2

In Example 2, a hydrogen-absorbing alloy powder for the negative electrode was prepared in the same manner as that in Example 1 above, except that the mixture ratio of the rare-earth elements La, Pr, and Nd to Mg, Ni, Al, and Co was changed from that of Example 1 above, so that a hydrogen-absorbing alloy powder was obtained having a composition of (La_{0.2}Pr_{0.5}Nd_{0.3})_{0.89}Mg_{0.11}Ni_{3.17}Al_{0.23}Co_{0.10} and a weight-average particle size of 65 μm.

Then, a cylindrical alkaline storage battery having a design capacity of 1500 mAh was fabricated in the same manner as in Example 1 above, except that this hydrogen-absorbing alloy powder was used.

### Example 3

In Example 3 as well, a hydrogen-absorbing alloy powder for the negative electrode was prepared in the same manner as that in Example 1 above, except that the mixture ratio of the rare-earth elements La, Pr, and Nd to Mg, Ni, Al, and Co was changed from that of Example 1 above, so that hydrogen-absorbing alloy powder was obtained having a composition of (La_{0.2}Pr_{0.5}Nd_{0.3})_{0.79}Mg_{0.21}Ni_{3.03}Al_{0.17}Co_{0.10} and a weight-average particle size of 65 μm.

Then, a cylindrical alkaline storage battery having a design capacity of 1500 mAh was fabricated in the same manner as in Example 1 above, except that this hydrogen-absorbing alloy powder was used.

### Comparative Example 1

In Comparative Example 1, a hydrogen-absorbing alloy powder for the negative electrode was prepared in the following manner. A rare-earth element La was mixed with Mg, Ni, Al, and Co so that a predetermined alloy composition was obtained. Thereafter the mixture was melted at 1500° C. by an induction furnace, and was then cooled to obtain an ingot of hydrogen-absorbing alloy. The composition of the resultant hydrogen-absorbing alloy was analyzed by inductively-coupled plasma spectrometry (ICP), and consequently, the composition of the hydrogen-absorbing alloy was found to be La_{0.7}Mg_{0.3}Ni_{3.2}Al_{0.1}Co_{0.1}.

The ingot of the hydrogen-absorbing alloy was annealed at 950° C. for 10 hours in an argon atmosphere, and thereafter the ingot of the hydrogen-absorbing alloy was mechanically pulverized in an inert atmosphere to obtain a hydrogen-absorbing alloy powder having the foregoing composition and a weight-average particle size of 65 μm.

Then, a cylindrical alkaline storage battery having a design capacity of 1500 mAh was fabricated in the same manner as in Example 1 above, except that this hydrogen-absorbing alloy powder was used.

### Comparative Example 2

In Comparative Example 2, a hydrogen-absorbing alloy powder for the negative electrode was prepared in the same manner as in Comparative Example 1 above, except that the process step of annealing the hydrogen-absorbing alloy ingot in an argon atmosphere at 950° C. for 10 hours, as in Comparative Example 1 above, was omitted, whereby a hydrogen-absorbing alloy powder was obtained having a composition of La_{0.7}Mg_{0.3}Ni_{3.2}Al_{0.1}Co_{0.1} and a weight-average particle size of 65 μm.

Then, a cylindrical alkaline storage battery having a design capacity of 1500 mAh was fabricated in the same manner as in Example 1 above, except that this hydrogen-absorbing alloy powder was used.

In addition, each of the ingots of the hydrogen-absorbing alloys prepared in Examples 1 to 3 and Comparative Examples 1 and 2 were buried in resin, which was then cured, and this was cut to study the cross section of each hydrogen-absorbing alloy by observing reflected electron images with a scanning electron microscope (SEM). According to the colors of the reflected electron images observed, phases were classified, and the area ratios of the phases were calculated. Furthermore, the abundance of each of the elements was determined by electron probe microanalysis (EPMA), to classify phases according to the distribution of the elements, and the area ratios of the phases were calculated. The results are shown in Table 1 below.

TABLE 1

| | | Reflected electron | | | | | |
|---|---|---|---|---|---|---|---|
| | | image | | EPMA analysis | | | Area |
| | | | Area | Element | Main | Area | percentage |
| | Type of hydrogen-absorbing alloy | Color | ratio | Distribution | Phase | ratio | (%) |
| Ex. 1 | (La_{0.2}Pr_{0.5}Nd_{0.3})_{0.83}Mg_{0.17}Ni_{3.03}Al_{0.17}Co_{0.10} | White | 0.950 | Mg: small, | ✓ | 0.950 | 95.0 |
| | | | | Al: large | | | |
| | | Light gray | 0.045 | Mg: large, | | 0.045 | 4.5 |
| | | | | Al: small | | | |
| | | Black | 0.005 | Mg: medium, | | 0.005 | 0.5 |
| | | | | Al: medium | | | |
| Ex. 2 | (La_{0.2}Pr_{0.5}Nd_{0.3})_{0.89}Mg_{0.11}Ni_{3.17}Al_{0.23}Co_{0.10} | White | 0.995 | Mg: medium, | ✓ | 0.995 | 99.5 |
| | | | | Al: medium | | | |
| | | Light gray | 0.005 | Al: large, Mg: medium | | 0.004 | 0.4 |
| | | | | Al: small, Mg: medium | | 0.001 | 0.1 |
| Ex. 3 | (La_{0.2}Pr_{0.5}Nd_{0.3})_{0.79}Mg_{0.21}Ni_{3.03}Al_{0.17}Co_{0.10} | White | 0.996 | Mg: medium, | ✓ | 0.953 | 95.3 |
| | | | | Al: medium | | | |
| | | | | Mg: small, | | 0.022 | 2.2 |
| | | | | Al: large | | | |
| | | | | Mg: large, | | 0.021 | 2.1 |
| | | | | Al: small | | | |
| | | Black | 0.004 | Mg: large, | | 0.004 | 0.4 |
| | | | | Al: small | | | |
| Comp. Ex. 1 | La_{0.7}Mg_{0.3}Ni_{3.2}Al_{0.1}Co_{0.1} (annealed) | White | 0.95 | Mg: small, | ✓ | 0.50 | 50 |
| | | | | Al: large | | | |
| | | | | Mg: large, | | 0.45 | 45 |
| | | | | Al: small | | | |
| | | Light gray | 0.05 | Mg: medium, | | 0.05 | 5 |
| | | | | Al: medium | | | |
| Comp. Ex. 2 | La_{0.7}Mg_{0.3}Ni_{3.2}Al_{0.1}Co_{0.1} (not annealed) | White | 0.40 | Mg: large, | ✓ | 0.40 | 40 |
| | | | | Al: small | | | |
| | | Light gray | 0.30 | Mg: small, | | 0.30 | 30 |
| | | | | Al: large | | | |
| | | Black | 0.30 | Mg: small, | | 0.30 | 30 |
| | | | | Al: large | | | |

The results demonstrate that the area percentages of the main phases composed of a uniform metal phase with a uniform composition accounted for 60% or greater in the hydrogen-absorbing alloy powders prepared in Examples 1 to 3, whereas no main phase that was composed of a uniform metal phase with a uniform composition and that accounted for an area percentage of 60% or greater existed in the hydrogen-absorbing alloy powders of Comparative Examples 1 and 2.

Next, the alkaline storage batteries of Examples 1 to 3 and Comparative Examples 1 and 2, prepared in the above-described manners, were charged at a current of 150 mAh for 16 hours and thereafter discharged at a current of 1500 mA until the battery voltage reached 1.0 V. This charge-discharge cycle was repeated three times to activate the alkaline storage batteries of Examples 1 to 3 and Comparative Examples 1 and 2.

With the activated alkaline storage batteries, the average particle sizes Da of the hydrogen-absorbing alloy powders in the negative electrodes were determined, and their particle size reduction ratios were calculated with respect to the original average particle sizes Do of the respective powders prepared in the foregoing manners, using the following equation. The results are shown in Table 2 below.
Particle size reduction ratio (%)=(Da/Do)×100

In addition, the alkaline storage batteries of Examples 1 to 3 and Comparative Examples 1 and 2, which were activated in the just-described manner, were charged at a current of 1500 mA, and after the battery voltage reached the maximum value, the batteries were further charged until the voltage lowered by 10 mV. Thereafter, they were discharged at a current of 1500 mA until the battery voltage reached 1.0 V. This charge-discharge cycle was repeated to obtain the cycle life of each of the batteries, at which the discharge capacity of each battery lowered to 60% of the discharge capacity at the first cycle. The cycle life of each of the alkaline storage batteries was calculated as a relative value with respect to the cycle life of the alkaline storage battery of Example 1 being 100. The results are also shown in Table 2 below.

TABLE 2

| | Area | Particle size | |
|---|---|---|---|
| | percentage of | reduction | |
| | main phase | ratio | |
| | (%) | (%) | Cycle life |
| Ex. 1 | 95.0 | 60 | 100 |
| Ex. 2 | 99.5 | 66 | 120 |
| Ex. 3 | 95.3 | 55 | 80 |
| Comp. Ex. 1 | 50 | 50 | 25 |
| Comp. Ex. 2 | 40 | 42 | 50 |

The results demonstrate that the alkaline storage batteries of Examples 1 to 3 proved to have lower particle size reduction ratios than the alkaline storage batteries of Comparative Examples 1 and 2. It should be noted that in each of the alkaline storage batteries of Examples 1 to 3, the hydrogen-absorbing alloy having a main phase composed of a uniform metal phase with a uniform composition was utilized for the negative electrode, and the area percentage of the main phase composed of a uniform metal structure with a constant composition in a cross-section of the alloy accounted for 60% or greater. On the other hand, no main phase that was composed of a uniform metal phase with a uniform composition and that had an area percentage of 60% or greater existed in the alkaline storage batteries of Comparative Examples 1 and 2. This indicates that in the alkaline storage batteries of Examples 1 to 3, the hydrogen-absorbing alloy powders were prevented from pulverizing, and their cycle life was significantly improved.

Only selected embodiments have been chosen to illustrate the present invention. To those skilled in the art, however, it will be apparent from the foregoing disclosure that various changes and modifications can be made herein without departing from the scope of the invention as defined in the appended claims. Furthermore, the foregoing description of the embodiments according to the present invention is provided for illustration only, and not for limiting the invention as defined by the appended claims and their equivalents.

This application claims priority of Japanese Patent Application No. 2005-039927 filed Feb. 17, 2005, which is incorporated herein by reference.

What is claimed is:

1. A hydrogen-absorbing alloy for alkaline storage batteries, comprising: at least a rare-earth element, magnesium, nickel, and aluminum, wherein: the hydrogen-absorbing alloy is represented by the formula Ln₁₋ₓMgₓNi_{y-a-b}AlₐM_{b}, where: Ln is at least one element selected from the group consisting of Ti, Zr, and a rare-earth element including Y; M is at least one element selected from the group consisting of V, Nb, Ta, Cr, Mo, Mn, Fe, Co, Ga, Zn, Sn, In, Cu, Si, P, B, and Zr; 0.05≦x≦0.35; 0.05≦a≦0.30; 0≦b≦0.5; 2.8≦y-a-b≦3.9; and the hydrogen-absorbing alloy has a main phase composed of a uniform metal phase with a uniform composition, the main phase having an area percentage in a cross-section of the alloy of 60% or greater.

2. The hydrogen-absorbing alloy for alkaline storage batteries according to claim 1, wherein the area percentage of the main phase is 90% or greater.

3. An alkaline storage battery comprising:
a positive electrode;
a negative electrode containing the hydrogen-absorbing alloy according to claim 1; and
an alkaline electrolyte solution.

4. An alkaline storage battery comprising:
a positive electrode;
a negative electrode containing the hydrogen-absorbing alloy according to claim 2; and
an alkaline electrolyte solution.
